(19) United States
(12) Patent Application Publication
(10) Pub. No.: US 2002/0052836 A1
(43) Pub. Date: May 2, 2002

(54) Method and apparatus for determining a prepayment score for an individual applicant

(76) Inventors: Yuri Galperin, Oak Hill, VA (US); Vladimir Fishman, Farmington, CT (US); William A. Eginton, Leesburg, VA (US)

Correspondence Address: Roberts Abokhair & Mardula, LLC, Suite 1000, 11800 Sunrise Drive, Reston, VA, 20191-5302, US

(21) Appl. No.: 09/942,983

(22) Filed: Aug. 30, 2001

Related U.S. Application Data
(60) Provisional application No. 60/228,954, filed on Aug. 31, 2000.

(51) Int. Cl. G06F 17/60

(52) U.S. Cl. 705/38

(57) ABSTRACT

A method and apparatus is disclosed for determining the prepayment propensity of individual borrowers. Early payment of debt instruments, such as loans and leases, can lead to losses being suffered by lenders. The present invention analyzes the demographics associated with a particular borrower to determine both the individual and group based prepayment propensity. The history of the borrower, the history of the borrower's demographic group, interest rate trends and other factors are then used to calculate a prepayment score that can be used by the lender to determine the propensity of a given borrower to prepay the instrument in question. The score of the individual borrower can be used to estimate the profitability of a debt instrument and allow the lender to make appropriate adjustments prior to issuing the instrument. The individual prepayment scores of a lender's or broker's clients can also be used to rate the lender or broker.

### RELATED APPLICATIONS

This application claims the benefit of Provisional Application Ser. No. 60/228,954, filed Aug. 31, 2000, which is incorporated herein in its entirety.

### FIELD OF THE INVENTION

This invention relates generally to receiving applications for and processing of lending transactions. More specifically this invention provides a method and apparatus to assess the prepayment propensity of a borrower in the form of a prepayment “score” to enable assessment of (i) the value of mortgages, second mortgages, home equity loans or other debt instruments for investors, (ii) the value of credit card accounts and balance transfers, (iii) the value of term loans and leases, (iv) the behavior of brokers with respect to churning, (v) the valuation of existing portfolios, (vi) the risk management of institutions that hold debt instruments, and (vii) the pricing of mortgage portfolio servicing contracts.

### BACKGROUND OF THE INVENTION

By way of an introductory example, consider the most common of debt instruments, the consumer mortgage. The value of a mortgage depends, in large part, on the duration of the mortgage. At the inception of the mortgage there are broker fees and various other settlement costs that are charged to the lender. When a mortgage extends for the term of many years, there is an opportunity for the lender to recoup costs of putting a mortgage in place for a given consumer and to make profit on that mortgage. This is particularly important for all business organizations that lend money, but it is particularly important for those mortgage financing organizations which have stockholders and other investors.

When a mortgage loan is paid off early due to refinancing, depending upon how early in the term, the mortgage loan is paid off, there is the possibility that the lending institution can actually take a loss on the particular mortgage. The rate of prepayment depends on a number of objective factors. For example, during times of decreasing mortgage rates, on average, more consumers refinance their home loans than would otherwise occur, in order to obtain a lower monthly payment. However, for a given macroeconomic environment and other measurable, objective factors, each consumer evidences an individual propensity to prepay a loan. This prepayment propensity reflects the consumer's demographic and other objective attributes. A system that can assess such individual prepayment behavior by a consumer in advance of the loan will lead to more profitable loans being made, and hence the enhanced availability of funds for loans to more consumer-borrowers. The present invention therefore may be applied, without limitation, to a) the pricing of mortgages and other debt instruments, b) the valuation of existing portfolios of debt instruments, and c) the risk management of institutions that hold debt instruments.

Additionally, the present invention is not limited to the type of debt instrument or lending transaction to which the prepayment score is useful. The invention includes, but is not limited to, mortgages (consumer and commercial), second mortgages, refinanced mortgages, consumer loans, commercial loans, asset-backed loans, consumer leases, commercial leases, credit card accounts, credit card balance transfers, debt consolidation loans (term notes, etc.), mortgage-backed securities (i.e., mortgage pass through, CMO's, mortgage-backed bonds, principal-only, interest-only, etc.), and any servicing contract for these lending transactions that performs financially based on the quality (i.e., duration) of the cash flow.

A further element of the present invention is the monitoring and scoring of brokers for these lending transactions. Mortgage brokers deal with both consumer-borrowers and lenders-clients. In order to generate brokerage fees, it is possible for a broker to encourage its consumer-borrowers to refinance their mortgages frequently and prematurely. When this occurs, the mortgage broker generates a fee for the broker, however, early prepayment of the prior mortgage instrument can result in a loss for the lender. Thus the present invention also has the capability to score mortgage broker prepayment behavior.

The behavior of a broker is sometimes not all heinous. Sometimes a consumer, who is particularly attuned to the rise and fall of interest rates, will simply be the one who changes mortgage instruments more frequently than the average consumer. The broker who is scored based upon the prepayment behavior of the consumers that the broker brings to lenders, would like to know the pre-payment propensity for the given consumer. This would be useful so that the mortgage broker can optimize the broker's relationship with its lender-clients by only bringing consumer-borrowers who have a low prepayment propensity.

Therefore, lenders and brokers badly need the ability to better measure prepayment behavior in advance of incurring marketing or underwriting charges; these expenses are too great to absorb blindly on behalf of consumers with poor prepayment propensities. Indeed, a beneficial use of the invention would be in managing the initial marketing effort itself. For example, only those customers who can be shown to score favorably for prepayment behavior might receive a solicitation for a mortgage product A. Consumers who are revealed to represent a substantial prepayment risk may be offered a more suitable mortgage product B, reflecting the increased risk. In this way, enhanced customers segmentation and product design initiatives converge to benefit consumers and their sources of debt financing, to the benefit of each.

To understand the potential impact of national prepayment scoring standard, as manifested in the present invention, one need look no farther than the existing default risk scoring standard, owned and distributed by Fair, Isaac and Company, Inc. (Fair Isaac) for over 30 years. By establishing a standard methodology for scoring borrower default risk, and broadly disseminating it, Fair Isaac dramatically enhanced mortgage lender insight into expected loan dynamics. In finance, enhanced insight is synonymous with enhanced information. Enhanced information implies reduced risk for the lender. Finally, reduced lender risk profiles produce lower costs of capital. In other words, because Fair Isaac standardized successfully a fungible measurement of default risk, more money is available for consumers to borrow, at better and cheaper interest rates. The market is more efficient than before and everyone benefits.

To further qualifying the timeliness of the invention, please refer to exhibit 1, “Green Tree chief returns $23 million . . . ” The Wall Street Journal, March, 1998. This story highlights the industry wide uncertainty surrounding prepayment speeds in consumer debt portfolios. One industry leading company, Green Tree Financial, “has been hit hard the past year by escalating loan losses in the painful recognition that its accounting has been too aggressive. Also, an unexpected wave of loan prepayments hit the industry, as borrowers sought lower interest rates, indicating working-class consumers were not as unsophisticated as lenders had believed.” Stated plainly, Green Tree overstated prior year earnings significantly, exercising its option under GAAP accounting to roll forward and capture in advance projected lending profits, even though those very profits were merely estimated based in part on arbitrary prepayment assumptions. In large measure because Green Tree badly miscalculated these prepayments speed assumptions, in 1997 the company was forced to charge off $390 million of 1996 reported profit. In 1998 the company was sold off to Conseco.

Earlier disclosures in the area of prepayment scoring in a lending context are limited or nonexistent. U.S. Pat. No. 5,696,907, entitled “System and Method for Performing Risk and Credit Analysis of Financial Service Applications,” issued to Tom. The Tom patent discloses using a neural network to mimic a loan officer's underwriting decision making. The method of the Tom patent is based on a non-iterative regression process that produces an approval criterion that is useful in preparing new or modified underwriting guidelines to increase profitability and minimize losses for a future portfolio of loans. A prepayment observation is used in the neural net as a negative flag, but no prepayment scoring system is utilized in the Tom patent.

In view of the prior art, there is a clear need for measuring and predicting a consumer's prepayment propensity, as well as a clear and strong need for a method and apparatus to produce such a measuring and predictive parameter.

### BRIEF SUMMARY OF THE INVENTION

The system and method of the present invention generally works in the following manner: the service bureau or broker will electronically capture individual loan applications from consumers. Those loan applications will be sent to lenders for evaluation. The lender, using the present invention submits the loan application for review and analysis. The loan application will be reviewed by the present invention according to a sophisticated economic and customer behavior model, which will score the prepayment behavior of candidate borrowers. The score for these borrowers, which is an index of their prepayment propensity, will be electronically returned to the lender. The lender will in turn use the prepayment score and calibrate an appropriate mortgage price including the setting of interest rates, fees, broker commissions, and potentially consumer rewards. Using this consumer scoring technique, a lending institution can seek to contact or contract with those consumers who display a low propensity to prepay.

The advanced scoring of customer prepayment propensities materially improves the lender's to risk profile as regards new lending customers. This novel insight adds value to the marketing, underwriting, lending, administrative process for first and second mortgages, credit card balance transfers, and asset-backed term loans such as automobile loans. By assisting lenders in their efforts to segment customers according to this crucial behavior metric, waste and excess costs are driven from the lending economy. More money is thus available, more cheaply, for more people.

To the borrower, this system offers several advantages. First, more favorable loan terms can be made to those consumers who exhibit a beneficial borrowing behavior, i.e., borrowers who are not likely to prepay their loans but instead maintain their loans for a profitable duration. Further, dealing with a stable borrower market results in a more favorable financial environment on for all lenders thereby mitigating the risk of loss and, in the normal course of all efficient markets, passing that financial advantage onto borrowers generally.

Once again, the irrefutable economic relationship between financial risk-taking and expected financial reward informs the environment addressed by the present invention. If lenders reduce their risks-and by extension their costs-through enhanced prepayment scoring, ultimate borrowing costs paid by consumers will decline.

For the loan originator, the system offers several advantages. The loan originator can more efficiently price the particular loan. Further the loan originator can more efficiently select brokers and intermediaries who will select the best borrowers.

Further, the system and method of the present invention will lead to more efficient direct and indirect marketing investments by identifying individual consumers and groups of consumers who exhibit the most beneficial borrowing behavior, i.e., a propensity not to prepay financial obligations.

Given that direct marketing costs are exploding as the conventional direct channels (e.g. mail and outbound telemarketing) become saturated, any available efficiency in the direct marketing process is highly desirable. For example, in the marketing of home equity lines of credit (i.e. second mortgages), direct-mail response rates are now, on average, running below 0.3% (i.e. below 3/10ths of one percent). Obviously, some fraction of even this small respondent sample will prove ill-suited, as regards prepayment behavior, for the debt product being marketed. Therefore, the tailoring of specific debt products to consumers of specific prepayment behavior characteristics is essential to the efficient pricing of debt instruments. Lead generation, third-party data acquisition, underwriting, yield spread calculations all directly inform debt instrument profitability, and are all beneficially affected by the present invention.

Finally, in the context of sophisticated asset liability management (ALM), subtle prepayment behavior analysis provides significant benefits to its practitioners. Because ALM, as a primary objective, seeks to minimize destructive asymmetries in asset and liability cash flows, intelligent risk managers will utilize debt contracts of varying expected durations to strengthen their balance sheet. For example, a lender's risk manager may seek multiple classes of debt instrument, reflecting multiple prepayment profiles, in order to assure himself of adequate incoming cash flow to sustain his expected liability cash outflows. In the matching, therefore, of expected cash in- and out-flows, the prudent risk manager utilizes a carefully segmented portfolio of debt instruments scored by prepayment propensities (and other meaures) and priced accordingly, to avert liquidity crises.

An additional, equally valuable use of the present invention is in the valuation of existing mortgage or debt instrument blocks of business. This valuation may be required by lender risk managers, auditors, regulators, or investors; it may reflect stakeholder interest in actively managing asset-liability risk, or it may be performed as part of the merger and acquisition appraisal. In all instances, the prepayment scoring system quantifies from a granular perspective upward to a pool, or block perspective, the prepayment speed characteristics of the debt instruments. As we have seen in the Green Tree case, failing to adequately price prepayment risk has enormous balance sheet implications, and typically leads one to grossly over value a portfolio or the enterprise itself.

For auditors, the system of the present invention offers a quantitative measure of prepayment risk thus reducing auditor exposure to “claw-back” write-downs. This situation occurs in the case of issuers that secure these mortgages and, under the generally applied accounting procedures (GAAP) accelerate and capture earnings based on certain prepayment assumptions. If those prepayment assumptions are incorrect, prior year financial statements are incorrect and massive charges are required to reflect lower portfolio earnings.

For banking regulators, the system of the present invention offers the ability to quantify balance sheet risk resulting from expected consumer prepayment behavior. This will allow regulators to more precisely measure and assign minimum bank capital levels.

For credit rating agencies, the ability to score according to an objective, standard methodology prepayment risk provides enormous assistance in rating a lender's creditworthiness. Rating agencies function, effectively, as credit market bellweathers. Lending institutions are dependent on favorable credit ratings in order to float their institutional debt at advantageous rates; rating agencies, as in the case of regulators, evaluate carefully lenders' claims of capital adequacy; the capital (cash reserves) retained by lenders is directly and immediately affected by debt instrument prepayment speeds. This is because, under GAAP accounting rules, lenders are allowed to capture a substantial percentage of the future expected profits for a given contracted debt instrument, and those profits are themselves substantially dependent on the assumed life of the instrument. (In the case of subprime mortgages, for example, profits may double if the mortgage is maintained in force for four years instead of three). If those profits are overstated, they must be reversed, with resultant charges reducing lender capital (capital: paid-in cash investments plus retained profits). Therefore, rating agencies must scrutinize lender portfolio prepayment speed assumptions, because if those assumptions prove false, then the lender will suffer a reduction in capital. Any significant impairment of lender capital necessarily suggests a reduction in its credit rating. Credit rating agencies will be major beneficiaries and users of the present invention.

For investment bankers, the system of present invention establishes a standardized prepayment methodology that allows merger and acquisition advisers to be able to quantitatively measure the balance sheet risk in a target banking or mortgage company. In addition, investment bank usage of the present invention will include its application to debt instrument securitization. Securitization describes the process by which pools of mortgage or other debt instruments are purchased by investment banks-in their capacity as underwriters-and re-sold to institutional and public investors as reconstituted securities. Typically, these securitizations benefit originators of debt, because they realize significant acceleration in realized profits; they also significantly diversify their risks by selling significant aspects of the debt instrument to asset underwriters and others. However, the typical debt instrument securitization proceeds with the originating lender retaining significant prepayment risk; if prepayment speeds accelerate beyond levels assumed in the securitization pricing process, the originating lender is held responsible. Hence the invention, by measuring the expected prepayment behavior and scoring in according to an accepted, industry standard method, will improve the securitization process and render it more efficient. Once again, this will reduce costs for all participants and free up more capital for lower-cost consumer borrowing.

For investors, the method of the present invention provides a way to make investment decisions based upon quantified debt instrument prepayment behavior risk for lending institutions in which investors might want to invest, or to evaluate the relative stability of mortgage securities that are backed by individual debt instruments.

These and other advantages of the present invention are described in reference to the specification that follows.

### BRIEF DESCRIPTION OF THE DRAWINGS

FIG. 1 is an overview of the process of the present invention.

FIG. 2 is a block diagram of the present invention.

FIG. 3 is a block diagram showing the user interface module connections.

FIG. 4 is block diagram showing the interactions with the prepayment historical data.

FIG. 5 is a block diagram showing the interactions with the econometric model.

FIG. 6 is a block diagram showing the factors that are used by the user interface module.

### DETAILED DESCRIPTION OF THE INVENTION

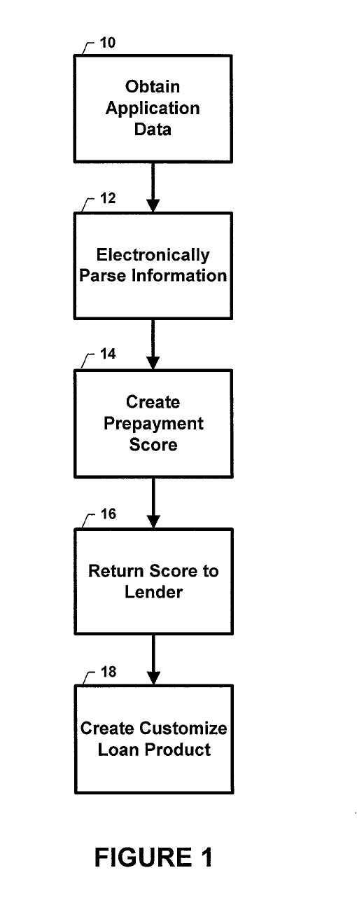

Referring to FIG. 1, an overview of the process of the present invention is shown. The mortgage broker or lending institution first obtains a loan application from a borrower 10. That information is electronically transmitted to the present invention, which parses the information 12 of the loan application into various categories that are relevant to the scoring of the potential loan. The loan application contents are parsed based upon the information needs of a sophisticated, mathematical model resident in the present invention. A prepayment score is then derived 14 for the particular consumer as a function of the particular loan type being requested, and in further view of the interest rate environment in which the loan is being processed (i.e. rising or falling interest rates). As previously noted this score is an indication of the prepayment propensity of a particular consumer. The prepayment score is then returned to the lender 16. Thereafter the lender can create a customized loan product that rewards favorable prepayment behavior of the consumer 18.

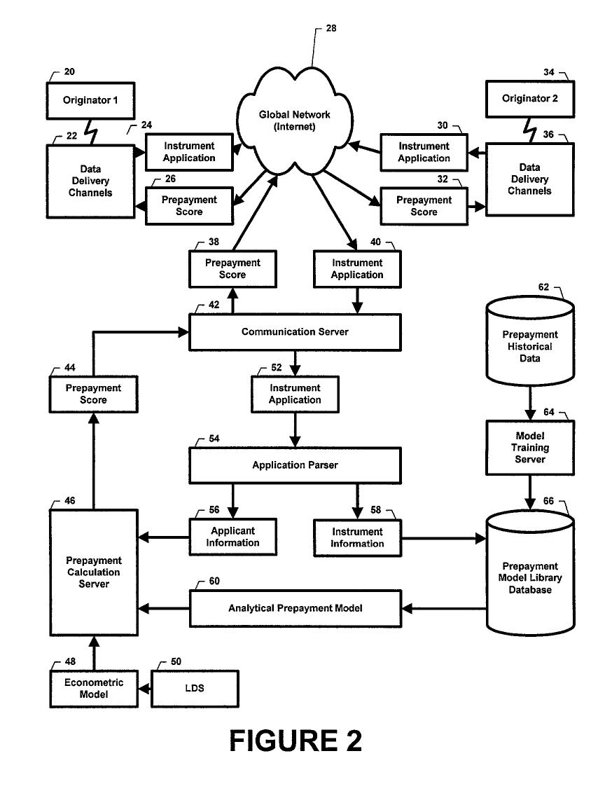

Referring to FIG. 2, an overview of the system of the present invention is shown. A loan originator 20 receives the application from a potential consumer. That application is then input to the loan originator's data delivery channels 22. Such data delivery channels 22 are (without limitation) e-mail, fax, Internet, and generally other electronic means. Other loan originators 34 also send their respective consumer applications over their own data delivery channels 36.

The present invention anticipates delivery of loan applications 24 over the Internet 28 or other digital electronic means such as wireless communications methods as well. Electronic loan applications 40 enter the system of the present invention through a communication server 42. The loan information concerning a given consumer is then submitted to an application parser 52. Application parser 52 divides the information into loan information 58 and applicant information 56. Loan information 58 is information that relates to the amount, the term, down payment, loan type, and other information important and relating to the amount of money to be loaned. Applicant information 56 is information such as name, address, Social Security number, and other demographic information concerning the applicant.

Loan information 56 is fed into a prepayment model library database 66. The prepayment model library database 66 comprises information concerning prepayment historical data 62. The results are fed into model training server 64 which processes prepayment historical data 62 of both an individual and demographic groups which in turn provides updates to the model library database 66. Once loan information 58 is processed by the prepayment model library database 66 an analytical prepayment model 60, which is based upon the loan information 58 is provided to the prepayment calculation server 46. Prepayment calculation server 46 receives additional information from econometric model 48 which establishes the relationship among the wide variety of variables. Econometric model 48 generates interest rate, mortgage rate and other economic parameters that, arrayed in time series, comprise scenarios utilized by the prepayment calculations server. These scenarios are generated from the Low Discrepancy Sequence (LDS) logic, rather than using random number generation. The LDS logic affords significantly higher model accuracy with the same number of scenarios.

Once a prepayment score 44 is derived by prepayment calculation server 46, prepayment score 44 is sent to the communication server 42 and is transmitted over the Internet (or other electronic channels) 28 through the data delivery channels 22 or 36 back to loan originators 20 or 34 who can then either approve, disapprove, or create customized loan product for the consumer.

Prepayment score 38 is calculated based upon the following model. The specific prepayment analysis of the present invention is conceptually shown below.

The following variables:

A=(a₁, a₂, . . . , aₙ)

L=(l₁, l₂, . . . , lₘ)

are vectors of the applicant's data and loan parameters.

Eₛ(t)=(e₁ₛ(t),e₂ₛ(t), . . . eₖₛ(t)); s=1, . . . , S

denotes a set of Low Discrepancy Sequence (LDS)-based scenarios of the econometric parameters, which have been generated by the RTH Linked Index Econometric Model. Thus the model is a set of stochastic differential equations that describe the dynamics and interaction of major macroeconomic indicators, each relevant to the prepayment propensity calculation.

Analytical Prepayment Model [symbol] , which varies with the types of loan applied for, is trained to calculate prepayment value pₛ in a given scenario based on the applicant's data (A), loan parameters (L), and econometric parameters (E):

pₛ(t)= [symbol] (A,L,Eₛ(t))

Total prepayment, accumulated by the time T in scenario s, can be calculated as:

$${P}_{s} ( T ) = {\prod }_{i} {p}_{s} ( {t}_{i} )$$

Then, total prepayment at time T is given by:

$$P ( T ) = ( 1 / S ) {{\sum }_{s = 1}}^{s} {P}_{s} ( T )$$

Finally, the prepayment score is:

$$S c o r e = {\sum }_{T} T P ( T )$$

The analytical model that produces the prepayment score may be further informed by additional external behavioral or econometric factors, based on subsequent research, as well as the aforementioned behavioral scoring of mortgage broker behavior.

The present invention may also be represented in an alternative embodiment in the form of the credit engineering workstation (CEW). This CEW (more fully described below) comprises a user interface which allows a loan originator to conduct all of the prepayment calculations, model analysis, and pricing of the present invention using the prepayment model first noted above.

The CEW operates in either a Unix or Windows NT environment using Oracle, SQL server, Sybase, DB2, or Informix database support. The CEW also uses CORBA or, structured object models together with a JAVA/HTML browser based graphical user interface.

The subroutines of the CEW all contribute to the end goal of determining the prepayment propensity of a consumer. For example, subroutines of the present invention deal supports the generation of various interest rate scenarios, and subsequent economic scenarios model fitting processes that fit the modeled interest rates scenarios to historical and current interest rate yield curve performance as well as to other macro economic indicators.

Part of the system includes rewards pricing logic to efficiently measure and price the impact of rewards on consumer prepayment behavior. For example it would be most beneficial to a lender to reward the consumer for not prepaying the lender's loan. Such a reward could be assessed in terms of its impact on the consumer prepayment behavior. The system therefore permits the end-user to design pro forma rewards structures and to test their impact on prospective consumer prepayment behavior.

Various user definable screens also establish default spreads, prepayment spreads, broker commission schedules, and other financial factors that influence the pricing of the product to be offered to the consumer. Various other economic scenarios are collected via the user interface and combined with various probabilities and default data as well as other lender defined criteria result in rationally priced end-user mortgage contracts.

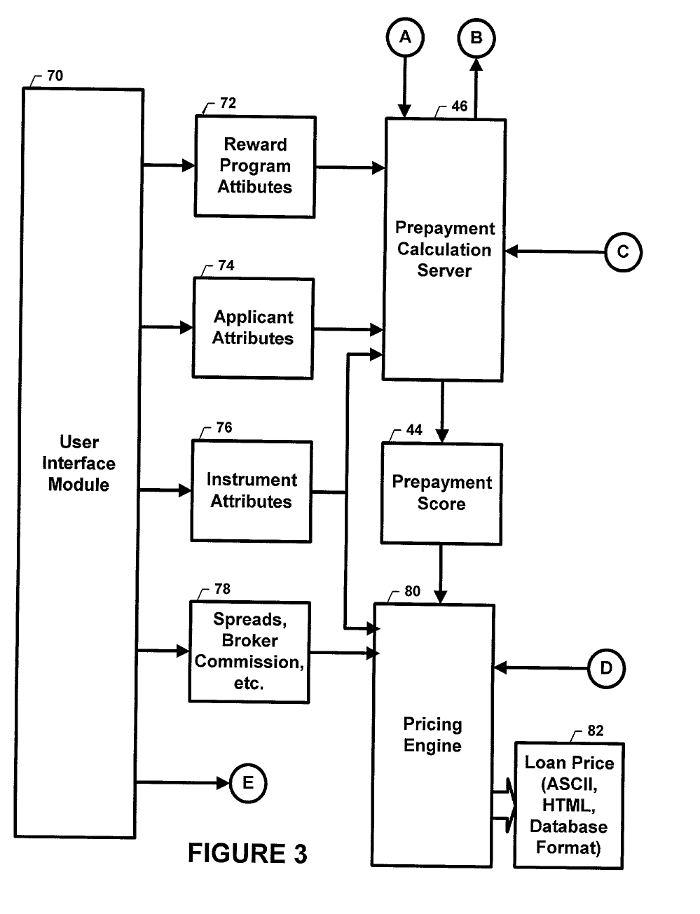

Referring to FIG. 3, further information concerning the CEW of the present invention shown. The system comprises user interface module 70 which is the basic graphical user interface and other software that allows an originator to provide information concerning a consumer who wishes to borrow money from lender. The user interface module allows the collection of loan attributes 76, applicant attributes 74, and reward program attributes 72. In addition user interface module 70 collects or calculates spreads, broker commissions and other costs associated with the loan 78. Loan attributes 76 and other loan related costs are fed into pricing engine 84 which, with other information, assists in creating an appropriate loan price 86.

Loan attributes 76, applicant attributes 74, and reward program attributes 72 all which have an impact on the value of the loan are fed into prepayment calculation server 80. Prepayment calculation server 80 receives input from the various prepayment model parameters and creates prepayment score 82.

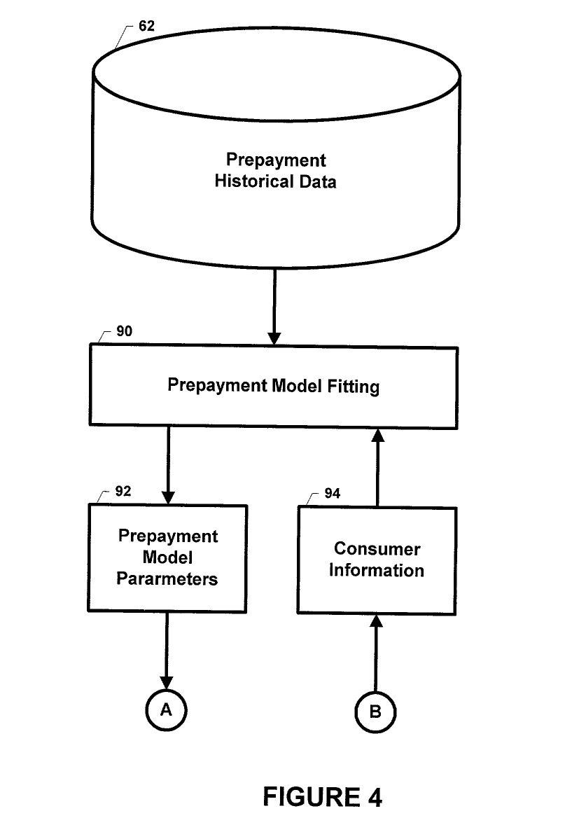

Referring to FIG. 4, a block diagram showing the interactions which are necessary to create a prepayment model are shown. Consumer information 96 which consists of applicant attributes 74 and loan attributes 76 are fed into a prepayment model fitting 92 module. Prepayment model fitting 92 establishes various prepayment model parameters 94 based upon prepayment historical data 90. Once the appropriate prepayment model is created by prepayment model fitting 92, a model is returned to the prepayment calculation server for the calculation of the prepayment score of the particular consumer given the type of loan to consumer is requesting. The prepayment calculation server also benefits from input from an econometric model scenario generator.

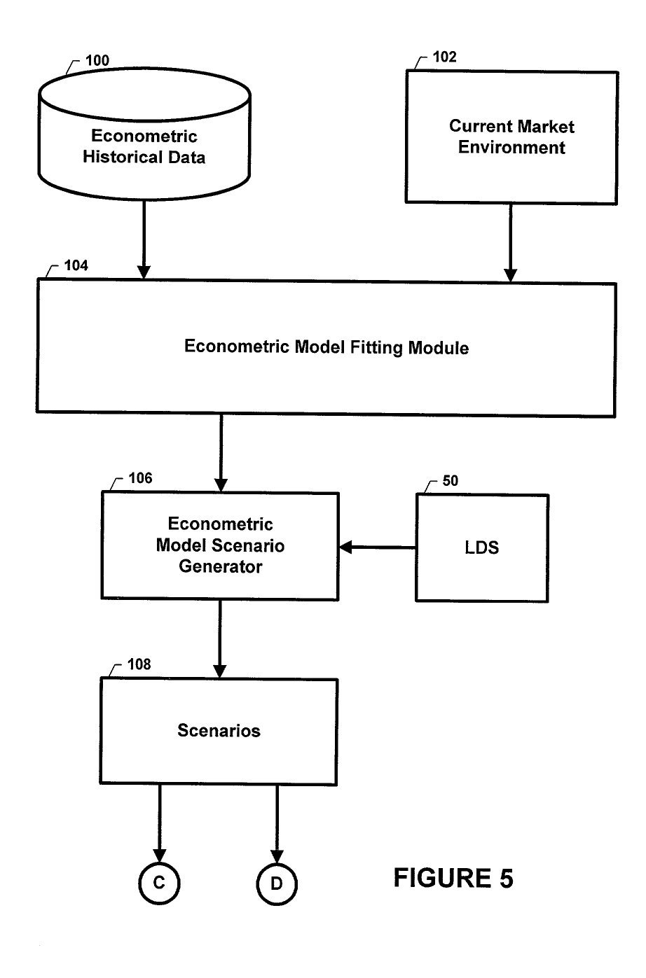

Referring to FIG. 5, the interactions for the econometric model are shown. Econometric model scenario generator 106 receives input from econometric model fitting module 104 and LDS scenarios 108. Econometric model fitting module 104 receives information from econometric historical data 100 and current market environment 102 which comprises, without limitation, information concerning rising or falling interest rates and trends. The information from econometric historical data 100 concerns the demographic group to which the consumer belongs and other econometric information such as age, income, cedit rating, occupation and other factors. The information from current market environment 102 concerns the direction and velocity of changes to interest rates. Econometric model scenario generator 106 processes the information and produces various scenarios based on the information.

Referring again to FIG. 3, prepayment calculation server 80 creates prepayment score 44 for the particular consumer in question. Prepayment score 44 is based upon the established prepayment model and the generated econometric model. Prepayment score 44 is transmitted to the pricing engine 82 to establish the pricing of the loan product to be offered to the consumer in question.

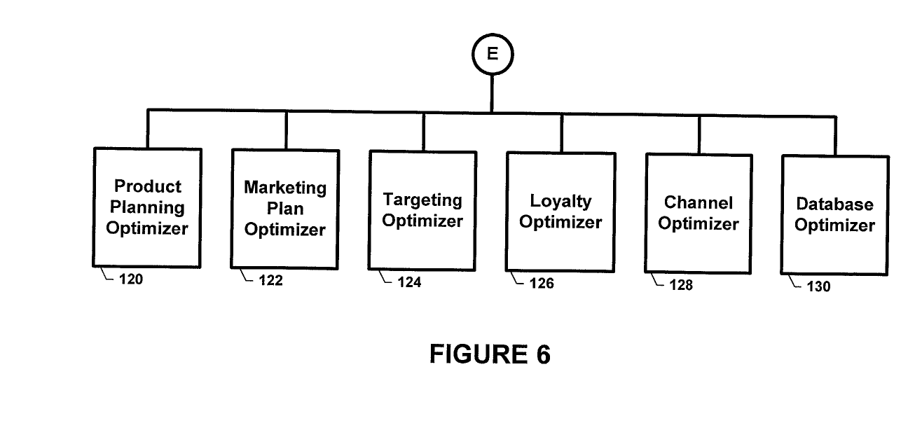

Referring to FIG. 6, additional parameters which the user interface module uses to create the various scenarios are shown. Additional aspects of the present invention provide for creation of new products. Strategy optimizer 122 is based upon acceptance of offered products by consumers and input from and relating to other products are on the market. Strategy optimizer 122 generates marketing plans based upon individual lenders' portfolios. Such a market plan could assist the lender in offering new products to the marketplace that are more profitable for the lender. The system includes targeting optimizer 124 which provides a way to offer loan products to those consumers having the most favorable prepayment characteristics, i.e., a low propensity to prepay loans made. The system also comprises loyalty optimizer 126 which models and defines offers and other inducements to consumers to reward financially advantageous consumer behavior. Channel optimizer 128 is part of the present invention. Channel optimizer 128 analyzes the channels of delivery of financial product offerings to evaluate and determine the channel that is the most efficient way to deliver various financial products. The system also comprises database optimizer 130 which receives and organizes information in the various databases to constantly build and refined prepayment historical data 90 and econometric historical data 100.

The target platform on which the system of the present invention will run is either an Intel Pentium processor based system with typically 32 megabytes of RAM, hard disk storage and retrieval, and communications capability using the TCP/IP protocol. Alternatively the system will also run under the UNIX operating system on a Sun Solaris platform. In both cases displays for users are anticipated as is the ability to output hard copy reports. In typical operation, a plurality of users, remote from the system site will access the system via private networks or over the Internet to send the information necessary for the present invention to make the desired calculations leading to the prepayment score. This score is then sent back to the requesting user at the remote terminal.

Although described herein with respect to a mortgage loan or loan, the present invention is applicable to numerous financial instruments that have a value that depends on the particular consumer's actions over time. The value of typical debt instruments, such as, but not limited to, mortgages, second mortgages, home equity loans, car loans, school loans, term loans, leases, credit card accounts, and credit card balance transfers, depend on a continued stream of cash and are therefore affected significantly by prepayment.

The value of other instruments that depend on the cash stream over time, such as open-end car leases and whole-life insurance policies, can also depend on the consumer's actions, and therefore, for purposes of this invention can be considered as a form of debt instrument. In the car lease scenario, predicting the probability of a consumer electing to purchase or return the car before the end of the lease (prepay) is important in determining the value of the lease. Even a consumer's predisposition to keeping (purchasing at residual value price, a type of prepayment) or returning the car at the end of the lease can be used to modify the lease terms to the leasing entity's advantage.

Likewise, the likelihood of a consumer to cash out the surrender value of a whole-life insurance policy (another form of prepayment, albeit in the opposite direction, that ends the stream of cash) can significantly affect the ultimate value of the policy to the insurer.

Known database and computer-based data mining techniques can be used for analyzing: the value of financial instruments (and portfolios in which they are packaged) based on the prepayment score associated with each of them; the risk associated with portfolios containing the financial instruments; and the pricing for servicing those portfolios. Additionally, instruments can be packaged together into portfolios based, at least in part, on the prepayment scores of the applicants.

A system and method for prepayment score generation has been described. Those skilled in the art will appreciate that other variations of the present invention are possible without departing from the scope of the invention as described.

What is claimed is:

1] A system for determining a prepayment score representative of prepayment propensity of an individual applicant, comprising:
at least one debt instrument origination computer terminal for accepting and transmitting a debt instrument application of an individual applicant;
a computer network connected to the at least one debt instrument origination computer terminal for receiving the transmitted debt instrument application of the individual applicant;
a communication server connected to the computer network for receiving the transmitted debt instrument application of the individual applicant;
an application parser connected to the communications server for receiving the transmitted debt instrument application of the individual applicant from the communications server and parsing the information into debt instrument information and applicant information;
a prepayment model library database comprising debt instrument prepayment models connected to the application parser for receiving the debt instrument information and fitting the debt instrument information into the debt instrument prepayment models and for transmitting debt instrument prepayment models that match the debt instrument information; and
a prepayment calculation server comprising a prepayment score generation model connected to the prepayment model library database for receiving the debt instrument prepayment models and calculating a prepayment score for the debt instrument application of the individual applicant based upon the debt instrument prepayment model and the prepayment score generation model, the prepayment calculation server being further adapted to transmit the prepayment score to at least one debt instrument origination computer terminal via the communications server and the computer network;
where the prepayment score is calculated from the formula:
$$S c o r e = {\sum }_{T} T P ( T )$$
where T represents time and P represents prepayment; and
wherein the at least one debt instrument origination computer terminal is adapted to use the prepayment score to adjust terms of the debt instrument of the individual applicant.

2] The system for determining a prepayment score of claim [c1], where the prepayment model library database further comprises:
a model training server for creating the debt instrument prepayment models for the prepayment model library database; and
prepayment historical data storage means connected to the model training server, the prepayment historical data further comprises prepayment statistics regarding debt instruments of various types.

3] The system for determining a prepayment score of claim [c1], where the prepayment calculation server further comprises an econometric model that generates Low Discrepancy Sequence (LDS)-based scenarios of econometric parameters for input to the prepayment calculation server.

4] The system for determining a prepayment score of claim [c1], further comprising means adapted to calculate a total prepayment at time T from the formula:
$$P ( T ) = ( 1 / S ) {{\sum }_{s = 1}}^{S} {P}_{s} ( T )$$
where S represents the number of scenarios and P represents the prepayment amount for a given scenario.

5] The system for determining a prepayment score of claim [c4], further comprising means adapted to calculate the total prepayment, accumulated by time, in scenario s from the formula:
$${P}_{s} ( T ) = {\prod }_{i} {p}_{s} ( {t}_{i} )$$
where p(t) is a prepayment value.

6] The system for determining a prepayment score of claim [c5], further comprising means adapted to calculate the prepayment value in a given scenario from the formula:
pₛ(t)= [symbol] (A,L,Eₛ(t)
where A is the applicant's data, L is the debt instrument parameters, E is the economic parameters and [symbol] is an analytical prepayment model.

7] The system for determining a prepayment score of claim [c1], where the applicant is either an individual consumer or an individual household.

8] The system for determining a prepayment score of claim [c1], further comprising computer-based means for using data associated with the prepayment score of the applicant and terms of the debt instrument to determine a calculation selected from the group consisting of: a value of the debt instrument, a value of a portfolio containing the debt instrument, a risk to holders of the debt instrument, and a price of a servicing contract for a portfolio containing said debt instrument.

9] A method for determining a prepayment score representative of prepayment propensity of an individual applicant, comprising:
collecting debt instrument and applicant information at a debt instrument originator;
transmitting the debt instrument and applicant information over a network;
receiving the debt instrument and applicant information at a service bureau;
the service bureau calculating a prepayment score the individual applicant, where the prepayment score is calculated from the formula:
$$S c o r e = {\sum }_{T} T P ( T )$$
where T represents time and P represents prepayment;
the service bureau returning the prepayment score over the network to the debt instrument originator; and
the debt instrument originator using the prepayment score to customize a debt instrument product for the individual applicant.

10] The method for determining a prepayment score of claim [c9], where calculating a prepayment score for the applicant comprises parsing the information into debt instrument information and applicant information.

11] The method for determining a prepayment score of claim [c10], further comprising providing the applicant information to a prepayment model library database and the debt instrument information to a prepayment calculation server.

12] The method for determining a prepayment score of claim [c11], further comprising the prepayment model library determining the prepayment model that best applies to the debt instrument information and providing that prepayment model to the prepayment calculation server.

13] The method for determining a prepayment score of claim [c12], further comprising the prepayment calculation server receiving a prepayment model and an econometric model, where the prepayment calculation server further calculates a prepayment score for the applicant.

14] The method for determining a prepayment score of claim [c13], where the total prepayment at time T is calculated from the formula:
$$P ( T ) = ( 1 / S ) {{\sum }_{s = 1}}^{S} {P}_{s} ( T )$$
where S represents the number of scenarios and P represents the prepayment amount for a given scenario.

15] The method for determining a prepayment score of claim [c14], where the total prepayment, accumulated by time, in scenario s is calculated from the formula:
$${P}_{s} ( T ) = {\prod }_{i} {p}_{s} ( {t}_{i} )$$
where p(t) is a prepayment value.

16] The method for determining a prepayment score of claim [c15], where the prepayment value in a given scenario is calculated from the formula:
pₛ(t)= [symbol] (A,L,Eₛ(t))
where A is the applicant's data, L is the debt instrument parameters, E is the economic parameters and [symbol] is an analytical prepayment model.

17] The method for determining a prepayment score of claim [c9], where the applicant is defined as an individual consumer or an individual household.

18] The method for determining a prepayment score of claim [c9], further comprising rating a broker based on prepayment scores of applicants that are clients of said broker.

19] The method for determining a prepayment score of claim [c9], further comprising using the prepayment score of the applicant and terms of the debt instrument to assist in determining a calculation selected from the group consisting of: a value of the debt instrument, a value of a portfolio containing the debt instrument, a risk to holders of the debt instrument, and a price of a servicing contract for a portfolio containing said debt instrument.

20] The method for determining a prepayment score of claim [c9], further comprising packaging said debt instrument into a portfolio based, at least in part, on the prepayment score of the applicant.
